(19) United States
(12) Patent Application Publication
(10) Pub. No.: US 2024/0231367 A1
(43) Pub. Date: Jul. 11, 2024

(54) SYSTEM AND METHOD FOR OPERATING AN AIRCRAFT DURING A CRUISE PHASE OF FLIGHT

(71) Applicant: THE BOEING COMPANY, Arlington, VA (US)

(72) Inventors: Veeresh Kumar Masaru Narasimhulu, Bellevue, WA (US); Chaitanya Pavan Kumar Aripirala, Bangalore (IN); James Louis Tylee, Seattle, WA (US)

(73) Assignee: THE BOEING COMPANY, Arlington, VA (US)

(21) Appl. No.: 18/468,943

(22) Filed: Sep. 18, 2023

Related U.S. Application Data
(63) Continuation-in-part of application No. 18/150,856, filed on Jan. 6, 2023.

(51) Int. Cl. G05D 1/10; G05D 1/00

(52) U.S. Cl. CPC G05D 1/101; G05D 1/0088

(57) ABSTRACT

A system and a method for operating an aircraft during a cruise phase of flight include a control unit configured to receive data regarding one or both of a current flight or one or more previous flights of the aircraft from one or more sensors of the aircraft. The control unit is further configured to determine efficient cruise phase parameters for the aircraft based on the data. The aircraft is operated during the cruise phase of one or both of the current flight or one or more future flights according to the efficient cruise phase parameters.

### CROSS-REFERENCE TO RELATED APPLICATIONS

This application is a continuation-in-part of U.S. patent application Ser. No. 18/150,856, filed Jan. 6, 2023, entitled “System and Method for Operating an Aircraft During a Climb Phase of Flight,” each of which is hereby incorporated by reference in its entirety.

### FIELD OF THE DISCLOSURE

Examples of the present disclosure generally relate to systems and methods for operating an aircraft during one or more phases of flight, such as a cruise phase.

### BACKGROUND OF THE DISCLOSURE

Aircraft are used to transport passengers and cargo between various locations. Numerous aircraft depart from and arrive at a typical airport every day.

Various phases of flight for an aircraft occur. For example, phases of flight for an aircraft include ground, climb, cruise, and descent. International Civil Aviation Organization (ICAO) and International Air Transport Association (IATA), for various purposes, define phases of a typical flight.

A climb phase of flight is between a takeoff and a top of climb, which is the beginning of a cruise phase of flight. A descent phase of flight is between the end of the cruise phase of flight, and landing. The climb phase of a commercial aircraft flight, for example, is typically demanding in terms of fuel consumption, as energy is required to gain both altitude and speed.

A cruise phase of a commercial aircraft flight can be demanding in terms of fuel consumption, as the cruise phase tends to be the longest phase of flight. Typically, test flight data are used to calibrate a cruise profile of an aircraft. The cruise profile relates to efficiency, and is used to develop an economy speed profile, which can be determined by cost index values related to trade-offs between fuel burn and time of flight. The efficiency of an aircraft flight is impacted by several factors including Mach speed bias, offsets, and tail degradation.

Notably, each aircraft is different to some extent in the way it is built, flown, and maintained. Accordingly, determining attributes for a phase of flight based on a single test aircraft typically does not account for various factors related to particular aircraft that are in use at a later time. Moreover, aircraft can be retrofit with aerodynamic surfaces, but the speed mapping based on a prior test aircraft is not updated, which further widens the gap between reality and perceived flight costs.

### SUMMARY OF THE DISCLOSURE

A need exists for a system and a method for accurately determining parameters and attributes for one or more phases of flight, such as a cruise phase of flight. Further, a need exists for a system and a method for efficiently operating an aircraft during one or more phases of flight, such as a cruise phase of flight.

With those needs in mind, certain examples of the present disclosure provide a system for operating an aircraft during a cruise phase of flight. The system includes a control unit configured to receive data regarding one or both of a current flight or one or more previous flights of the aircraft from one or more sensors of the aircraft. The control unit is further configured to determine efficient cruise phase parameters for the aircraft based on the data. The aircraft is operated during the cruise phase of one or both of the current flight or one or more future flights according to the efficient cruise phase parameters.

The system can also include the one or more sensors. The one or more sensors can include one or more flight recorders. The one or more sensors can also include one or more speed sensors, one or more altitude sensors, one or more position sensors, one or more ambient sensors, and/or one or more weight sensors.

In at least one example, the control unit is onboard the aircraft.

In at least one example, the control unit is configured to determine the efficient cruise phase parameters for a future flight of the aircraft based on the data received from one or more previous flights of the aircraft.

In at least one example, the control unit is configured to determine the efficient cruise phase parameters by generating one or more neural network models for the aircraft based on the data.

The control unit can be further configured to show the efficient cruise phase parameters on a monitor within a flight deck of the aircraft.

In at least one example, the control unit is configured to determine the efficient cruise phase parameters by determining an optimum cost index from a plurality of cost indices.

The control unit can be further configured to automatically operate controls of the aircraft during the cruise phase according to the efficient cruise phase parameters.

Certain examples of the present disclosure provide a method for operating an aircraft during a cruise phase of flight. The method includes receiving, by a control unit, data regarding one or both of a current flight or one or more previous flights of the aircraft from one or more sensors of the aircraft; and determining, by the control unit, efficient cruise phase parameters for the aircraft based on the data, wherein the aircraft is operated during the cruise phase of one or both of the current flight or one or more future flights according to the efficient cruise phase parameters.

Certain examples of the present disclosure provide a non-transitory computer-readable storage medium comprising executable instructions that, in response to execution, cause one or more control units comprising a processor, to perform operations including receiving data regarding one or both of a current flight or one or more previous flights of an aircraft from one or more sensors of the aircraft; and determining efficient cruise phase parameters for the aircraft based on the data, wherein the aircraft is operated during a cruise phase of one or both of the current flight or one or more future flights according to the efficient cruise phase parameters.

### BRIEF DESCRIPTION OF THE DRAWINGS

FIG. 1 illustrates a schematic block diagram of a system, according to an example of the present disclosure.

FIG. 2 illustrates a simplified view of a neural network fuel flow model for a cruise phase of a flight of an aircraft, according to an example of the present disclosure.

FIG. 3 illustrates a flow chart of a method for operating an aircraft during a cruise phase of flight, according to an example of the present disclosure.

FIG. 4 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Certain examples of the present disclosure provide systems and methods that use tail specific digital modeling combined with an ensemble of analytics algorithms to find a least cost flight parameter of cost index for a cruise phase of flight. The impact of cruise cost reduction on descent phase cost can also be considered as such can be interdependent.

The systems and methods described herein address drawbacks of inefficient speed profiles used during a cruise phase of flight. An inefficient speed profile typically results in higher fuel burn than desired. Airlines may not be able to effectively refine cruise speeds, but instead use a standard cruise speed profile based on a generic aircraft reference, which, in turn, leads to inefficiencies. However, such inefficiencies can be avoided by providing tail-specific and flight-specific speed advisories to an operator of the aircraft. The systems and methods described herein eliminate, minimize, or otherwise reduce the inefficiencies by leveraging flight data and applying data science and aircraft performance algorithms to determine the actual least cost cruise cost index/speeds, which include both cost of fuel and cost of time. Further, examples of the present disclosure reduce fuel burn, and therefore carbon emissions.

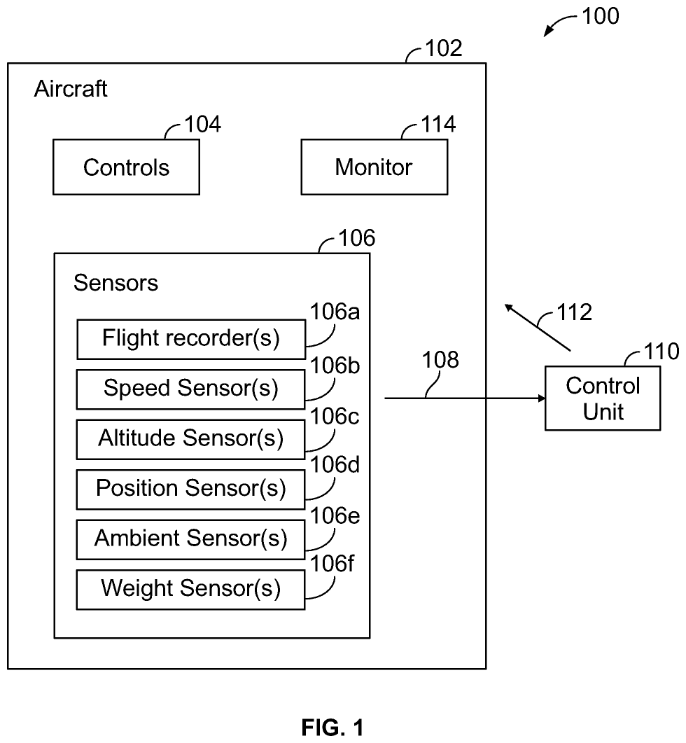

FIG. 1 illustrates a schematic block diagram of a system 100, according to an example of the present disclosure. In at least one example, the system 100 is for operating an aircraft 102 during a cruise phase of flight. The aircraft 102 includes controls 104 that are configured to control operation of the aircraft 102. For example, the controls 104 include one or more of a control handle, yoke, joystick, control surface controls, accelerators, decelerators, and/or the like.

The aircraft 102 further includes a plurality of sensors 106 that detect various aspects of the aircraft 102. As an example, the sensors 106 include one or more flight recorders 106a that record various aspects of the aircraft 102 during a flight, including the climb phase, the cruise phase, and the descent phase. A speed sensor 106b of the aircraft 102 outputs a speed signal indicative of a ground and/or air speed of the aircraft 102. An altitude sensor 106c of the aircraft 102 outputs an altitude signal indicative of an altitude of the aircraft 102. A position sensor 106d outputs a position signal of the aircraft. As an example, the position signal can be an automatic dependent surveillance-board (ADS-B) signal. As another example, the position signal can be a global positioning system (GPS) signal that is monitored by a corresponding GPS monitor. In at least one example, GPS allows for determination of position, and ADS-B provides a transmission system to broadcast the position, which can be determined through GPS and/or inertial sensors.

The sensors 106 can also include one or more ambient sensors 106e. For example, an ambient sensor 106e can include a temperature sensor that is configured to detect an ambient temperature surrounding the aircraft 102. As another example, an ambient sensor 106e can include a wind speed sensor.

The sensors 106 can also include one or more weight sensors 106f. For example, the weight sensors 106f can include a sensor that is configured to detect an overall weight of the aircraft. As another example, the weight sensors 106f can include a sensor that is configured to detect a fuel weight within the aircraft 102. As another example, the weight sensors 106f can include a sensor configured to determine a center of gravity of the aircraft 102.

The sensors 106 can include more or less sensors than shown. The sensors 106 can detect additional aspects of the aircraft 102 other than position, speed, and altitude. For example, one or more temperature sensors can detect temperatures of one or more portions of the aircraft (such as engine temperature sensors). As another example, fuel level sensors can detect a remaining fuel level of the aircraft.

The sensors 106 output data 108 indicative of the various aspects detected thereby. For example, the data 108 includes avionics data output by the flight recorder(s) 106a. A control unit 110 is in communication with the sensors 106 through one or more wired or wireless connections, and is configured to receive the data 108 from the sensors 106.

In at least one example, the control unit 110 is onboard the aircraft 102. For example, the control unit 110 can be part of a flight computer of the aircraft 102. As another example, the control unit 110 can be part of a handheld device (such as a smart phone or smart tablet), a portable computer, a computer workstation, and/or the like within the aircraft 102. As another example, the control unit 110 can be remote from the aircraft 102.

In operation, the sensors 106 detect various aspects of the aircraft 102 during a flight. For example, the sensors 106 detect various aspects of the aircraft 102 before and during one or more phases of flight, such as a climb phase, a cruise phase, and/or a descent phase of flight. In at least one example, the sensors 106 output the data 108 indicative of the various aspects of the aircraft 102 before and/or during the phases, such as the cruise phase of flight. The control unit 110 receives the data 108 for the specific, particular aircraft 102 (as opposed to a test aircraft). As described herein, the control unit 110 analyzes the data 108 to determine an efficient cruise phase for a future flight of the specific, particular aircraft 102. For example, the control unit 110 determines one or more cruise phase parameters, such as an efficient cruise speed (for example, vertical speed and horizontal speed in relation to the ground), altitude, time of cruise, and/or the like for the aircraft 102. Instead of relying on a generic determination for the cruise phase, the control unit 110 determines efficient cruise phase parameters (such as vertical speed, horizontal speed, time of cruise, altitude, and/or the like) based on actual data 108 output by the sensors 106 of the aircraft 102 during one or more actual flights of the aircraft 102. For example, the control unit 110 can determine efficient cruise phase parameters for a future flight of the aircraft 102 based on historical data of the aircraft 102, such as the data 108 from one or more previous flights. In at least one example, the control unit 110 determines the efficient cruise phase parameters for a future flight based on the data 108 received from an immediately prior flight of the aircraft 102. As another example, the control unit 110 determines the efficient cruise phase parameters for the future flight of the aircraft based on the data 108 from a plurality of previous flights, such as the most recent 10, 20, 30, 40, or more flights of the aircraft 102. In this manner, the additional data from a plurality of flights of the aircraft 102 provides a more robust and refined determination of the efficient cruise phase parameters.

In at least one example, the control unit 110 determines the efficient cruise phase parameters for a current or future flight of the aircraft 102 by generating one or more cruise phase models for the aircraft 102 based on the data 108 received from the actual aircraft 102 (that is, the specific tail associated with the aircraft 102), instead of a different aircraft or generic model.

In a least one example, the control unit 110 receives the data 108 from the sensors 106 in the form of one or more aircraft flight recording data sets, such as from the flight recorder(s) 106a. The control unit 110 analyzes the data 108 to determine an efficient (for example, optimal) speed and altitude for the actual, specific aircraft 102 from which the data 108 is recorded and output, and received by the control unit 110. As such, the control unit 110 uses real flight recording data of the specific aircraft 102 to adjust cruise phase performance. In at least one example, the control unit 110 receives the data 108 and generates a cost index optimization to enable easier use by pilots and also more accurate models of the aircraft fuel burn performance during the cruise phase. The control unit 110 refines fuel efficiency by using tail specific performance (that is, regarding the actual aircraft 102, in contrast to a different aircraft, such as a test aircraft).

In at least one example, the flight recorder(s) 106a includes an aircraft interface device and transmitter that outputs the data 108, such as avionics data, to the control unit 110. As noted, the control unit 110 is in communication with the flight recorder(s) 106a through one or more wired or wireless connections, such as through WiFi, Bluetooth, cellular, or other such connections. In at least one example, the control unit 110 determines the efficient cruise phase parameters and outputs a signal 112 including data regarding the efficient cruise phase parameters. A flight computer receives the signal 112, such as through one or more wired or wireless connections, and information regarding the efficient cruise phase parameters can be shown on a monitor 114 (such as an electronic screen, television, touch screen, and/or the like) within the flight deck.

After the flight of the aircraft 102, the data 108 can be stored, such as in cloud servers, which can be used to perform post-flight analytics to estimate savings, further fine tune performance models, and/or the like.

As described herein, the system 100 for operating the aircraft 102 during a cruise phase of flight includes the control unit 110, which is configured to receive the data 108 regarding one or both of a current flight or one or more previous flights of the aircraft 102 from the one or more sensors 106 of the aircraft 102. The control unit 110 is further configured to determine efficient cruise phase parameters for the aircraft 102 based on the data 108. The aircraft 102 is operated during the cruise phase of one or both of the current flight or one more future flights according to the efficient cruise phase parameters.

In at least one example, the control unit 110 generates an optimized cost index to enable easier use by pilots, and also more accurate models of the aircraft fuel burn performance during cruise phase. The control unit 110 increases fuel efficiency by using tail specific performance, which increases precision as compared to generic speeds generated by flight planning systems.

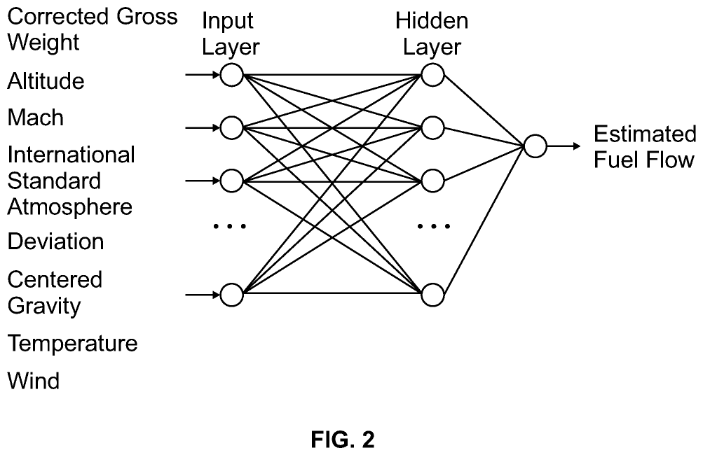

FIG. 2 illustrates a simplified view of a neural network fuel flow model for a cruise phase of a flight of an aircraft, according to an example of the present disclosure. Referring to FIGS. 1 and 2, in at least one example, the control unit 110 can implement an ensemble of methods in which different analytical techniques are applied on data to generate accurate and efficient cruise phase parameters.

Neural network models, such as the neural network fuel flow model shown in FIG. 2, can receive inputs, such as the data 108, which can include corrected gross weight of the aircraft 102, altitude of the aircraft, Mach (airspeed) of the aircraft 102, internal standard atmosphere deviation, center of gravity of the aircraft 102, ambient temperature, wind speed, and/or the like. The control unit 110 can generate the neural network models, such as the neural network fuel flow model. In at least one example, for a particular aircraft, such as the aircraft 102, the control unit 110 uses the data 108 received from the aircraft 102. As such, the control unit 110 analyzes data 108 from one or more actual flights of the specific aircraft 102 (as opposed to a different aircraft, such as a test aircraft). In at least one example, the control unit 110 generates and determines one or more deep neural network models from the data 108, such as the neural network shown in FIG. 2. For example, the control unit 110 determines the one or more deep neural networks to establish a fuel flow/burn model, as shown in FIG. 2.

In at least one example, the control unit 110 determines a cost index factor based on a deep neural-network based fuel flow model for a cruise phase of the aircraft 102. In at least one example, for each aircraft 102 (that is, a tail) the control unit 110 uses actual flight recordings to build tail specific deep neural network models, and estimates fuel flow during a cruise phase of flight. For a given flight condition, the control unit 110 iterates over a range of cost indices (such as based on a predetermined inflight cruise table) to determine the optimum cost index (or lowest-cost cost index). For each cost index, the control unit 110 estimates fuel flow for a cruise phase using fuel flow neural network models, and estimates a total cost including both fuel cost and time cost. Based on the determined total cost, the control unit then determines the cost index resulting in a minimum total cost. The control unit 110 can then provide a recommendation to a pilot, such as through the monitor 114, regarding the determined cost index.

In at least one example, for each candidate cost index, the control unit 110 estimates fuel flow for a cruise phase using a fuel flow neural network model. In at least one example, the control unit 110 estimates such fuel flow using cruise fuel flow models. The control unit 110 then calculates a total cost for a cruise phase of flight. Based on the calculated total cost, the control unit 110 determines the cost index resulting in a minimum total cost.

As an example, in operation, the sensors 106 detect various aspects of the aircraft 102 during a flight. For example, the sensors 106 detect various aspects of the aircraft 102 before, during, and/or after a cruise phase of flight. The sensors 106 output the data 108 indicative of the various aspects of the aircraft 102 before, during, and/or after the cruise phase of flight. The control unit 110 receives the data 108 for the particular aircraft 102 (as opposed to a test aircraft). The control unit 110 analyzes the data 108 to determine an efficient cruise phase for a future flight of the specific, particular aircraft 102. For example, the control unit 110 determines an efficient cruise speed (for example, vertical speed and horizontal speed in relation to the ground) for the aircraft 102 based on the received data. Instead of relying on a generic determination for the cruise phase, the control unit 110 determines efficient cruise phase parameters (such as vertical speed, horizontal speed, altitude, and/or the like) based on actual data 108 output by the sensors 106 of the aircraft 102 during one or more actual flights of the aircraft 102. For example, the control unit 110 can determine efficient cruise phase parameters for a future flight of the aircraft 102 based on the data 108 from one or more previous flights. In at least one example, the control unit 110 determines the efficient cruise phase parameters for a future flight based on the data 108 received from an immediately prior flight of the aircraft 102. In this manner, the additional data from a plurality of flights of the aircraft 102 provides a more robust and refined determination of the efficient cruise phase parameters.

In at least one example, the control unit 110 determines the efficient cruise phase parameters for a current or future flight of the aircraft 102 by generating one or more cruise phase models for the aircraft 102 based on the data 108 received from the actual aircraft 102 (that is, the specific tail associated with the aircraft 102), instead of a different aircraft or generic model.

In a least one example, the control unit 110 receives the data 108 from the sensors 106 in the form of one or more aircraft flight recording data sets, such as from the flight recorder(s) 106a. The control unit 110 analyzes the data 108 to determine an efficient (for example, optimal) speed and/or altitude for the actual, specific aircraft 102 from which the data 108 is recorded and output, and received by the control unit 110. As such, the control unit 110 uses real flight recording data of the specific aircraft 102 to adjust cruise phase performance. In at least one example, the control unit 110 receives the data 108 and generates a cost index optimization to enable easier use by pilots and also more accurate models of the aircraft fuel burn performance during the cruise phase. The control unit 110 refines fuel efficiency by using tail specific performance data (that is, regarding the actual aircraft 102, in contrast to a different aircraft).

In at least one example, the control unit 110 determines the efficient cruise phase parameters and outputs a signal 112 including data regarding the efficient cruise phase parameters. A flight computer receives the signal 112, such as through one or more wired or wireless connections, and information regarding the efficient cruise phase parameters can be shown on a monitor 114 (such as an electronic screen, television, touch screen, and/or the like) within the flight deck.

After the flight of the aircraft 102, the data 108 can be stored, such as in cloud servers, which can be used to perform post-flight analytics to estimate savings, further fine tune performance models, and/or the like.

As described herein, in at least one example, the system 100 for operating the aircraft 102 during a cruise phase of flight includes the control unit 110, which is configured to receive the data 108 regarding one or both of a current flight or one or more previous flights of the aircraft 102 from the one or more sensors 106 of the aircraft 102. The control unit 110 is further configured to determine efficient cruise phase parameters for the aircraft 102 based on the data 108. The aircraft 102 is operated during the cruise phase of one or both of the current flight or one more future flights according to the efficient cruise phase parameters.

In at least one example, the control unit 110 determines a cost index factor based on inverse fuel mileage determined from flight data (such as from historical cruise phases of the aircraft 102). For example, the control unit 110 can calculate a normalized inverse fuel mileage for one or more cruise flight data points based on gross weight, true airspeed, and one or more coefficients.

Next, the control unit 110 can bin the data points based on a deduced cost index. The control unit 110 can then computes a mean normalized inverse fuel mileage for each bin. The control unit 110 can then determine an optimum cost index as a bin with the least normalized inverse fuel mileage.

In at least one example, the control unit 110 determines an optimal cost index factor based an actual flight data. For example, the control unit can iterate for data points from actual flight data, such as for each flight data point. The control unit 110 finds other flight data points with similar conditions based on gross weight, altitude, corrected gross weight, international standard atmosphere deviation, and/or the like. The control unit 110 then determines the inverse fuel mileage for all data points with similar conditions. The control unit 110 then determines a least cost index as the least value of inverse fuel mileage.

In at least one example, the control unit 110 builds a histogram based on the least cost index for each flight data point. In at least one example, the control unit 110 determines an optimum cost index as the cost index with a highest number of observations based on the histogram.

In at least one example, the control unit 110 determines an optimal cost index factor based on savings. For example, the control unit 110 iterates over a range of cost index values based on an inflight economy cruise Mach (airspeed) table. For each candidate cost index, the control unit 110 classifies optimum data points as flight data points with deduced cost index within a defined threshold from the candidate cost index. The control unit 110 then classifies remaining data points as non-optimum data points. For each data point, the control unit 110 computes a mean key performance indicator (KPI) for optimum points as OptKPI. KPI can be a customized metric of performance. The control unit 110 then further computes a mean KPI for non-optimum points as NOptKPI. Then, the control unit 110 determines savings as 100*(OptKPI−NOptKPI)/NOptKPI. The control unit 110 can determine an optimum cost index as the candidate cost index with the highest value of savings.

The control unit 110 can also analyze data summarized at a whole flight level to account for operational patterns of an airline. Based on the data, the control unit 110 determines optimal cost index factor values computed using the different methods above, and a consolidated value of optimal cost index factor, which can be determined by voting.

By looking at data and modeling the performance determined by different methods, issues with data are mitigated, and accurate optimum values are determined. The control unit 110 uses data from aircraft flight recording data sets to generate an optimal cruise speed profile for each tail (that is, the specific aircraft 102). In at least one example, the control unit 110 optimizes cost index to enable easier use by pilots, and also provide accurate models of fuel burn during cruise. The control unit 110 increases fuel efficiency for the aircraft 102 by using tail specific performance, which delivers more precise input, as compared to generic speeds generated by flight planning systems. In at least one example, tail specific calibration for each aircraft 102 is based on quick access recorder (QAR) data/continuous parameter logging (CPL) data output by flight recorders, which can be received and analyzed by the control unit 110.

In at least one example, the control unit 110 is configured to determine an optimum cost index for a cruise phase of flight from a plurality of cost indices. As an example, for a given flight condition, the control unit 110 iterates over a range of cost indices to determine the optimum cost index (or lowest-cost cost index). For each candidate cost index, the control unit 110 estimates fuel flow for a cruise phase, using the fuel flow neural network model shown in FIG. 2. In at least one further example, the control unit 110 then estimates fuel flow from the beginning of cruise until the end of cruise using one or more cruise fuel flow models. Next, the control unit 110 calculates the total cost for cruise phase. Based on such total cost, the control unit 110 determines the cost index resulting in the lowest total cost. Such cost index is then provided to a flight deck, such as by the control unit 110 showing the recommendation on the monitor 114.

Thus, instead of relying on a fixed Mach speed predetermined through a test aircraft and/or a generic model that is not specific to the aircraft 102, the control unit 110 analyzes the data 108 from the actual aircraft 102 itself to determine efficient cruise phase parameters for the aircraft 102. In at least one example, the control unit 110 determines an optimum cost index for a cruise phase of the aircraft 102. The optimum cost index can be determined based on one or more neural network models, such as the neural network model shown in FIG. 2.

The control unit 110 is configured to determine the efficient cruise phase parameters for the particular aircraft 102 based on the actual data 108 received from the aircraft 102, in contrast to a different aircraft, and/or a generic model of a different aircraft. In at least one example, the control unit 110 is configured to compute a total cost including cruise phase to establish an optimal cost index. Accordingly, the systems and methods described herein reduce fuel consumption, reduce emissions, and reduce time cost for the cruise phase of flight of the aircraft 102.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 110 may be or include one or more processors that are configured to control operation, as described herein.

The control unit 110 is configured to execute a set of instructions that are stored in one or more data storage units or elements (such as one or more memories), in order to process data. For example, the control unit 110 may include or be coupled to one or more memories. The data storage units may also store data or other information as desired or needed. The data storage units may be in the form of an information source or a physical memory element within a processing machine.

The set of instructions may include various commands that instruct the control unit 110 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 110. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 110 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

In at least one example, the control unit 110 can further control, at least in part, the controls 104 of the aircraft 102 to operate the aircraft 102 based on the determined efficient cruise phase parameters. For example, based on the determined efficient cruise phase parameters, the control unit 110 can automatically operate the controls 104 to increase or decrease ground or airspeed, altitude, and/or the like of the aircraft 102 based on the determined efficient cruise phase parameters.

In at least one example, all or part of the systems and methods described herein may be or otherwise include an artificial intelligence (AI) or machine-learning system that can automatically perform the operations of the methods also described herein. For example, the control unit 110 can be an artificial intelligence or machine learning system. These types of systems may be trained from outside information and/or self-trained to repeatedly improve the accuracy with how the data 108 is analyzed to determine the efficient cruise phase parameters based on a plurality of flights of the aircraft 102. Over time, these systems can improve by determining cruise phase parameters with increasing accuracy and speed, thereby significantly reducing the likelihood of any potential errors. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), or the like. The systems may be trained and re-trained using feedback from one or more prior analyses of the data 108, ensemble data, and/or other such data. Based on this feedback, the systems may be trained by adjusting one or more parameters, weights, rules, criteria, or the like, used in the analysis of the same. This process can be performed using the data 108 and ensemble data instead of training data, and may be repeated many times to repeatedly improve the determination of the cruise phase parameters. The training minimizes conflicts and interference by performing an iterative training algorithm, in which the systems are retrained with an updated set of data (for example, data 108 received during and/or after each flight of the aircraft 102) and based on the feedback examined prior to the most recent training of the systems. This provides a robust analysis model that can better determine the most cost effective and efficient climb and/or descent phase parameters for the aircraft 102.

Examples of the subject disclosure provide systems and methods that allow large amounts of data to be quickly and efficiently analyzed by a computing device. For example, the control unit 110 can analyze various aspects of flights of the aircraft 102 based on the data 108 received from the sensors 106. Further, the control unit 110 creates variables based on the various aspects, and determines efficient cruise phase parameters from the variables, which can be in a format not readily discernable by a human being. As such, large amounts of data, which may not be discernable by human beings, are being tracked and analyzed. The vast amounts of data are efficiently organized and/or analyzed by the control unit 110, as described herein. The control unit 110 analyzes the data in a relatively short time in order to quickly and efficiently determine the cruise phase parameters in real time. A human being would be incapable of efficiently analyzing such vast amounts of data in such a short time. As such, examples of the subject disclosure provide increased and efficient functionality, and vastly superior performance in relation to a human being analyzing the vast amounts of data.

In at least one embodiment, components of the system 100, such as the control unit 110, provide and/or enable a computer system to operate as a special computer system for determining efficient cruise phase parameters for the aircraft 102. The control unit 110 improves upon computing devices that use test data of a different test aircraft by allowing for the determination of aircraft-specific cruise phase parameters.

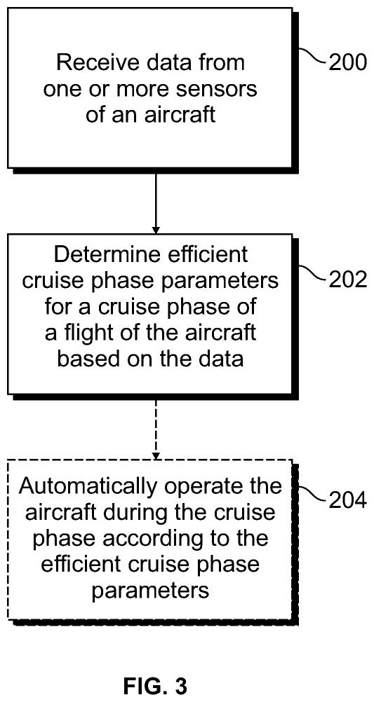

FIG. 3 illustrates a flow chart of a method for operating an aircraft during a cruise phase of flight, according to an example of the present disclosure. Referring to FIGS. 1 and 3, at 200, the control unit 110 receives the data 108 (such as avionics data) from one or more sensors 106 of the aircraft 102. In at least one example, the data 108 relates to various aspects of a current flight and/or one or more previous flights of the aircraft 102 (not another aircraft, such as a test aircraft). At 202, based on the data 108, the control unit 110 determines efficient cruise phase parameters (such as airspeed from beginning of cruise to end of cruise) for a cruise phase of a current or future flight of the aircraft 102. Optionally, at 204, the control unit 110 (and/or a flight computer of the aircraft 102) automatically operates the aircraft 102 during the cruise phase according to the efficient descent phase parameters.

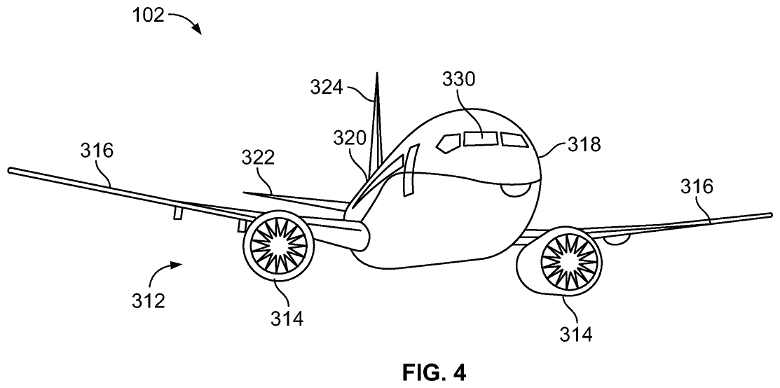

FIG. 4 illustrates a perspective front view of the aircraft 102, according to an example of the present disclosure. The aircraft 102 includes a propulsion system 312 that includes engines 314, for example. Optionally, the propulsion system 312 may include more engines 314 than shown. The engines 314 are carried by wings 316 of the aircraft 102. In other embodiments, the engines 314 may be carried by a fuselage 318 and/or an empennage 320. The empennage 320 may also support horizontal stabilizers 322 and a vertical stabilizer 324. The fuselage 318 of the aircraft 102 defines an internal cabin 330, which includes a flight deck or cockpit, one or more work sections (for example, galleys, personnel carry-on baggage areas, and the like), one or more passenger sections (for example, first class, business class, and coach sections), one or more lavatories, and/or the like. FIG. 4 shows an example of an aircraft 102. It is to be understood that the aircraft 102 can be sized, shaped, and configured differently than shown in FIG. 4.

Further, the disclosure comprises examples according to the following clauses:

Clause 1. A system for operating an aircraft during a cruise phase of flight, the system comprising:
a control unit configured to receive data regarding one or both of a current flight or one or more previous flights of the aircraft from one or more sensors of the aircraft,
wherein the control unit is further configured to determine efficient cruise phase parameters for the aircraft based on the data, and wherein the aircraft is operated during the cruise phase of one or both of the current flight or one or more future flights according to the efficient cruise phase parameters.

Clause 2. The system of Clause 1, further comprising the one or more sensors.

Clause 3. The system of Clause 2, wherein the one or more sensors comprise one or more flight recorders.

Clause 4. The system of Clause 3, wherein the one or more sensors further comprise one or more of one or more speed sensors, one or more altitude sensors, one or more position sensors, one or more ambient sensors, or one or more weight sensors.

Clause 5. The system of any of Clauses 1-4, wherein the control unit is onboard the aircraft.

Clause 6. The system of any of Clauses 1-5, wherein the control unit is configured to determine the efficient cruise phase parameters for a future flight of the aircraft based on the data received from one or more previous flights of the aircraft.

Clause 7. The system of any of Clauses 1-6, wherein the control unit is configured to determine the efficient cruise phase parameters by generating one or more neural network models for the aircraft based on the data.

Clause 8. The system of any of Clauses 1-7, wherein the control unit is further configured to show the efficient cruise phase parameters on a monitor within a flight deck of the aircraft.

Clause 9. The system of any of clauses 1-8, wherein the control unit is configured to determine the efficient cruise phase parameters by determining an optimum cost index from a plurality of cost indices.

Clause 10. The system of any of Clauses 1-9, wherein the control unit is further configured to automatically operate controls of the aircraft during the cruise phase according to the efficient cruise phase parameters.

Clause 11. A method for operating an aircraft during a cruise phase of flight, the method comprising:
receiving, by a control unit, data regarding one or both of a current flight or one or more previous flights of the aircraft from one or more sensors of the aircraft; and
determining, by the control unit, efficient cruise phase parameters for the aircraft based on the data, wherein the aircraft is operated during the cruise phase of one or both of the current flight or one or more future flights according to the efficient cruise phase parameters.

Clause 12. The method of Clause 11, wherein the one or more sensors comprise one or more flight recorders.

Clause 13. The method of Clause 12, wherein the one or more sensors further comprise one or more of one or more speed sensors, one or more altitude sensors, one or more position sensors, one or more ambient sensors, or one or more weight sensors.

Clause 14. The method of any of Clauses 11-13, further comprising disposing the control unit onboard the aircraft.

Clause 15. The method of any of Clauses 11-14, wherein said determining comprises determining the efficient cruise phase parameters for a future flight of the aircraft based on the data received from one or more previous flights of the aircraft.

Clause 16. The method of any of Clauses 11-15, wherein said determining comprises determining the efficient cruise phase parameters by generating one or more neural network models for the aircraft based on the data.

Clause 17. The method of any of clauses 11-16, further comprising showing, by the control unit, the efficient cruise phase parameters on a monitor within a flight deck of the aircraft.

Clause 18. The method of any of Clauses 11-17, wherein said determining comprises determining the efficient cruise phase parameters by determining an optimum cost index from a plurality of cost indices.

Clause 19. The method of any of Clauses 11-18, further comprising automatically operating, by the control unit, controls of the aircraft during the cruise phase according to the efficient descent phase parameters.

Clause 20. A non-transitory computer-readable storage medium comprising executable instructions that, in response to execution, cause one or more control units comprising a processor, to perform operations comprising:
receiving data regarding one or both of a current flight or one or more previous flights of an aircraft from one or more sensors of the aircraft; and
determining efficient cruise phase parameters for the aircraft based on the data, wherein the aircraft is operated during a cruise phase of one or both of the current flight or one or more future flights according to the efficient cruise phase parameters.

As described herein, examples of the present disclosure provide systems and methods for efficiently operating an aircraft during one or more phases of flight, such as a cruise phase of flight. Further, examples of the present disclosure provide systems and methods for accurately determining parameters and attributes for one or more phases of flight, such as a cruise phase of flight.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system for operating an aircraft during a cruise phase of flight, the system comprising:
a control unit configured to receive data regarding one or both of a current flight or one or more previous flights of the aircraft from one or more sensors of the aircraft,
wherein the control unit is further configured to determine efficient cruise phase parameters for the aircraft based on the data, and wherein the aircraft is operated during the cruise phase of one or both of the current flight or one or more future flights according to the efficient cruise phase parameters.

2. The system of claim 1, further comprising the one or more sensors.

3. The system of claim 2, wherein the one or more sensors comprise one or more flight recorders.

4. The system of claim 3, wherein the one or more sensors further comprise one or more of one or more speed sensors, one or more altitude sensors, one or more position sensors, one or more ambient sensors, or one or more weight sensors.

5. The system of claim 1, wherein the control unit is onboard the aircraft.

6. The system of claim 1, wherein the control unit is configured to determine the efficient cruise phase parameters for a future flight of the aircraft based on the data received from one or more previous flights of the aircraft.

7. The system of claim 1, wherein the control unit is configured to determine the efficient cruise phase parameters by generating one or more neural network models for the aircraft based on the data.

8. The system of claim 1, wherein the control unit is further configured to show the efficient cruise phase parameters on a monitor within a flight deck of the aircraft.

9. The system of claim 1, wherein the control unit is configured to determine the efficient cruise phase parameters by determining an optimum cost index from a plurality of cost indices.

10. The system of claim 1, wherein the control unit is further configured to automatically operate controls of the aircraft during the cruise phase according to the efficient cruise phase parameters.

11. A method for operating an aircraft during a cruise phase of flight, the method comprising:
receiving, by a control unit, data regarding one or both of a current flight or one or more previous flights of the aircraft from one or more sensors of the aircraft; and
determining, by the control unit, efficient cruise phase parameters for the aircraft based on the data, wherein the aircraft is operated during the cruise phase of one or both of the current flight or one or more future flights according to the efficient cruise phase parameters.

12. The method of claim 11, wherein the one or more sensors comprise one or more flight recorders.

13. The method of claim 12, wherein the one or more sensors further comprise one or more of one or more speed sensors, one or more altitude sensors, one or more position sensors, one or more ambient sensors, or one or more weight sensors.

14. The method of claim 11, further comprising disposing the control unit onboard the aircraft.

15. The method of claim 11, wherein said determining comprises determining the efficient cruise phase parameters for a future flight of the aircraft based on the data received from one or more previous flights of the aircraft.

16. The method of claim 11, wherein said determining comprises determining the efficient cruise phase parameters by generating one or more neural network models for the aircraft based on the data.

17. The method of claim 11, further comprising showing, by the control unit, the efficient cruise phase parameters on a monitor within a flight deck of the aircraft.

18. The method of claim 11, wherein said determining comprises determining the efficient cruise phase parameters by determining an optimum cost index from a plurality of cost indices.

19. The method of claim 11, further comprising automatically operating, by the control unit, controls of the aircraft during the cruise phase according to the efficient descent phase parameters.

20. A non-transitory computer-readable storage medium comprising executable instructions that, in response to execution, cause one or more control units comprising a processor, to perform operations comprising:
receiving data regarding one or both of a current flight or one or more previous flights of an aircraft from one or more sensors of the aircraft; and
determining efficient cruise phase parameters for the aircraft based on the data, wherein the aircraft is operated during a cruise phase of one or both of the current flight or one or more future flights according to the efficient cruise phase parameters.
